(19) United States
(12) Patent Application Publication
(10) Pub. No.: US 2025/0356181 A1
(43) Pub. Date: Nov. 20, 2025

(54) ENERGY EFFICIENCY OF HETEROGENEOUS MULTI-VOLTAGE DOMAIN DEEP NEURAL NETWORK ACCELERATORS THROUGH LEAKAGE REUSE FOR NEAR-MEMORY COMPUTING APPLICATIONS

(71) Applicant: Drexel University, Philadelphia, PA (US)

(72) Inventors: MD Shazzad Hossain, Lansdale, PA (US); Ioannis Savidis, Wallingford, PA (US)

(73) Assignee: Drexel University, Philadelphia, PA (US)

(21) Appl. No.: 18/566,704

(22) PCT Filed: Jun. 6, 2022
(86) PCT No.: PCT/US22/32356

§ 371 Date: Dec. 4, 2023

Related U.S. Application Data
(60) Provisional application No. 63/196,709, filed on Jun. 4, 2021.

(51) Int. Cl. G06N 3/065

(52) U.S. Cl. CPC G06N 3/065

(57) ABSTRACT

A multi-voltage domain heterogeneous deep neural network (DNN) accelerator architecture includes an architecture that a) executes multiple DNN models simultaneously with different power-performance operating points; and b) improves the energy efficiency of near-memory computing applications by recycling leakage current of idle memories. The multi-voltage heterogenous DNN architecture may be implemented on battery operated or battery less edge devices with on-device intelligence executing applications including computer vision, augmented/virtual reality, face recognition, image processing, and speech applications.

### BACKGROUND

### 1. Introduction

On-device artificial intelligence (AI) is a primary driving force for edge devices, where the global market for edge computing is projected to rise to $15.7 billion dollars by 2025 from the current market value of $3.6 billion dollars in 2020. Recent advances in deep neural network (DNN) models and DNN accelerators (customized hardware architectures optimized for DNN inferences) have provided significant improvement in incorporating intelligence into ubiquitous edge devices, which are designed with stringent energy efficiency requirement. The use of edge devices for applications including computer vision, augmented reality (AR), face recognition, image processing, and speech applications encourage DNNs with variable specifications. The state-of-the-art DNN models customized for resource constrained edge devices are capable of inference with as low as 2-bit arithmetic, while the training is demonstrated with as low as 4-bit arithmetic. As the bit precision is reduced, the execution of both inference and training is more feasible on edge devices. The progress on the hardware level implementations of optimized DNNs, however, has not sufficiently progressed as compared with the model and algorithmic breakthroughs made by the research community due to a) the lack of efficient circuits and architectures implementing the DNNs, and b) the higher power consumption due to the large number of computations and the large off and on-chip memories.

Regardless of the model, application, and hardware architecture, DNN accelerators require a sufficiently large data set, where the data is primarily categorized into three types: input activation, output activation, and weight (or filter). The DNN accelerators are efficient in performing the convolution operations on an array of processing elements (PEs), where each PE is composed of single or multiple multiply-and-accumulate (MAC) units and local memories. Storing and moving large data, however, pose challenges to improve the energy efficiency of the DNN accelerators. Prior research executing Google workloads on consumer devices shows that more than 60% of total system energy is spent on data movement. The large data sets required for DNN inference is stored in a combination of off-chip and on-chip memory, while choosing between off-chip and on-chip memory is determined by the fundamental trade-off between latency and energy consumption.

The on-chip memory such as SRAM or embedded DRAM (eDRAM) reduces latency at the cost of on-chip area, while off-chip memory such as DRAM does not incur on-chip area overhead at the cost of significant increase in latency and energy consumption of the overall system. The use of off-chip memory for edge devices with stringent energy budget is challenging and may not an optimal option since off-chip memory consumes order of magnitude more energy than on-chip memory. For example, a single off-chip DRAM access consumes 200 more energy than a MAC operation, while a single on-chip SRAM access consumes only 6 more energy than a MAC operation. As a result, the recent DNN accelerators store a larger portion of the data into the on-chip SRAM to avoid expensive (increased latency and energy per access) off-chip data traffic and also to improve the overall power-performance tradeoffs. For example, a 10-bit DNN accelerator implemented for near-threshold voltage (NTV) may use separate on-chip memory of 400 KB for each of activation memory and weight memory. In addition, a 16-bit Eyeriss accelerator implemented 181.5 KB of on-chip memory, where 0.5 KB of local memory is used for each PE. Additionally, the DaDianNao accelerator uses separate on-chip memory spaces for input/output activations and weights, where 4 MB and 32 MB of on-chip memory is used for, respectively, activations and weights. The on-chip SRAM size as the percentage of total on-chip area is 37%, 32%, 38%, 20%, and 67.97% for, respectively, TPU, Eyeriss V2, DiaNano, Mythic, and NTV accelerator architectures. A large on-chip memory, however, introduces a large leakage energy loss, where the leakage loss is further increased with technology scaling. For example, the power consumption of TPU during idle mode is 28 W (41% of total power), while 40 W is consumed during active mode. In addition, the power consumption due to the on-chip memory is 86.64% of total system power consumption in the NTV accelerator. Recently architectural techniques are proposed to alleviate the power overhead caused by data traffic such as a) in-memory computing, where computing is performed within the memory array and d) near-memory computing, where computing units are placed adjacent to the memory array.

In addition, the DNN accelerators are composed of a monolithic PE array (homogeneous accelerator architecture where all PEs are tasked with executing a single model at any given time), and all PEs are tied to a single power domain. The implementation of a monolithic DNN architecture limits any improvement in the energy efficiency and the performance as i) all PEs are allocated for a particular model regardless of the actual hardware requirements of the executing model and ii) the same supply voltage is applied to all PEs regardless of the specific latency and throughput requirements of the executing application.

### SUMMARY OF THE EMBODIMENTS

A power management technique may be used by applying leakage reuse (LR), a technique that recycles leakage current from idle circuits and the recycled leakage current becomes the source of current of active circuits, to implement near-memory computing of DNN accelerators. The proposed technique implements a heterogeneous and multi-voltage domain DNN accelerator architecture, where multiple PEs are grouped to form NsA number of subarrays that perform simultaneous execution of NsA number of models.

The leakage current of idle SRAM banks or blocks may be reused to supply current to the computing units of the DNN accelerators. Variants of custom DNN ASICs are possible, where regardless of the underlying architecture, the generic structure of each accelerator is composed of a) an array of processing elements, b) on-chip storage, c) off-chip storage, and d) communication network such as network on chips (NoCs). The proposed multi-voltage domain heterogeneous DNN accelerator that implements near-memory computing through leakage reuse is shown in FIG. 1, where the leakage current from idle on-chip storage (SRAM) is reused to deliver power to the computing units within the processing elements. A conventional power delivery system is assumed for the memory banks, where the supply voltage VDD is generated and distributed through a combination of integrated voltage regulators (IVRs) and on-chip voltage regulators (OCVRs) and the power management unit (PMU).

This disclosure describes in summary:
a design space exploration to analyze the computational demand and execution time of the DNN models and the multiple sub-layers of the models,
a leakage reuse (LR) technique applied to on-chip SRAM, where the leakage current from idle memory banks (memory banks that are in hold state) are recycled to deliver power to the adjacent processing elements in a DNN accelerator for near-memory computing, and
a multi-voltage domain heterogeneous DNN accelerator architecture that executes multiple models simultaneously with different power-performance operating points, where each PE sub-array is connected to an independent power domain.

### BRIEF DESCRIPTION OF THE DRAWINGS

FIG. 1 shows the architecture of the proposed multi-voltage domain DNN accelerator implementing near-memory computing through leakage reuse technique.

FIG. 2 shows an overview of bank-level leakage reuse technique, where leakage current from x number of SRAM banks (donors) are used to deliver power to y number of processing elements (receivers).

FIG. 3 shows a circuit representation of implemented SRAM bank (Bank0) with a cell array with m rows and n columns, where the supply and ground node of Bank0 is, respectively, VDD and VSS0.

FIG. 4 shows functionality of SRAM Bank0 (donor) with 4×4 cell array before and after implementing leakage reuse technique.

FIG. 5 shows intrinsic data retention in SRAM cell when implementing leakage reuse technique.

FIG. 6 shows functionality of a 4 bits carry look-ahead adder (receiver) when implementing leakage reuse technique.

FIGS. 7(a) and 7(b) show layer-by-layer processing of convolution operation: 7(a) algorithm to implement convolution for n number of CNN layers and 7(b) representation of a two-dimensional convolution operation of a CNN layer.

FIG. 8 shows characterization of the PE utilization and the average number of cycles to execute a set of DNN models for array sizes of 12×14, 6×6, and 2×2.

FIG. 9 shows the proposed multi-voltage domain heterogeneous DNN accelerator architecture implemented on Eyeriss based architecture.

FIG. 10 shows a single processing element with a 0.5 KB on-chip memory and two 8-bit MACs. The 0.5 KB memory is implemented as 16 16 16 SRAM banks, where at any given time one bank is utilized for leakage reuse.

FIG. 11 shows energy efficiency of the accelerator with a monolithic 12×14 PE array across five voltage domains.

FIGS. 12(a) and 12(b) show the monolithic 12 14 PE array executing the 27 convolutional layers of MobileNets model and operating at five different supply voltages is characterized for 12(a) energy consumption and 12(b) completion time of each layer.

FIGS. 13(a) and 13(b) show comparison of baseline, proposed technique without leakage reuse, and proposed technique with leakage reuse in 13(a) total power consumption and 13(b) throughput.

FIG. 14 shows characterization of energy efficiency in TOPS/W considering the total power consumption and delay of MAC arrays, which is applicable to any array size.

FIG. 15 shows characterization of total power consumption of 2×2 sub-arrays, where a single PE within each 2×2 sub-arrays is composed of 0.5 KB memory and two 8-bit MACs.

FIG. 16 shows characterization of total power consumption of the accelerator SoC for four different percentage of PE utilization for leakage reuse.

FIG. 17 shows Table 1.

### DETAILED DESCRIPTION OF THE EMBODIMENTS

### 2. Leakage Reuse in Memory

Leakage reuse is a technique where leakage current from an idle circuit block or core in a system-on-chip (SoC) is reused to deliver power to an active circuit block or core within the same SoC. Recently circuits and algorithms for simultaneous implementation of leakage reuse and power gating may also be used. In this research, however, leakage reuse technique is applied to on-chip memory (SRAM). Idle memories from which leakage current is reused are described as donors and computing units (PEs or MACs) to which reused charge is delivered as receivers. Unlike the prior techniques, the leakage current from memories (donors) are reused to supply power to computing units (receivers) to implement near-memory computing architecture. Through SPICE simulation it is determined that the stored data is not affected when leakage reuse technique is applied (more discussion is provided in Section 2B). Primary advantages of leakage reuse technique may include: a) reduction in leakage current through the donors, which improves the overall energy-efficiency of the system, b) the leakage energy, which is otherwise considered as complete waste of energy, is recycled to deliver power to computing units, and c) voltage regulators, which incurs significant area overhead and power consumption, are not required to generate and regulate supply voltages for the receivers.

### A. Bank-level Leakage Reuse

Large on-chip SRAM memories may be distributed across many smaller banks. The distributed memory banks allow for selective activation of banks that are required for specific workloads, which results in a significant reduction in the power consumption. Conventionally, the maximum allowed bit cells per row or column in a SRAM array is limited to less than 300 due to the increased RC delays on wordlines and bitlines. Moreover, the decoders become larger and slower as the word bit size or array size increases, which is in addition to the large, distributed RC load on word/bit line that is often compensated with large and slower transistors. Use of banks also increases the throughput as it allows for memory interleaving, which is a technique where a large on-chip/off-chip memory is evenly distributed across many smaller memory banks. In this way, the execution of read/write operation and waiting time to re-execute read/write operation on a specific memory address becomes smaller, which increases the throughput. Therefore, state-of-the-art on-chip storage is composed of many smaller SRAM banks.

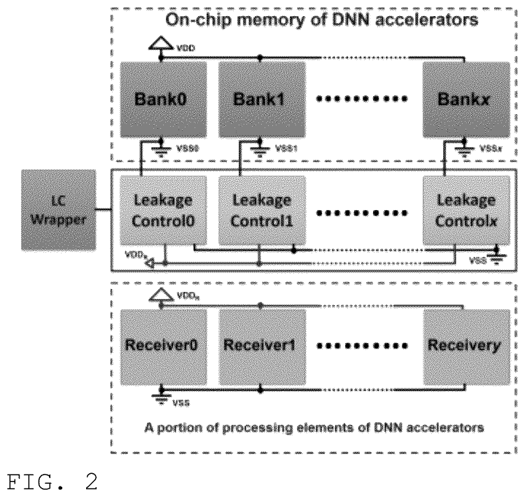

Given the significant benefits of using SRAM banks to improve both power consumption, performance, and throughput, in this research the leakage reuse technique is applied on the SRAM banks. In other words, the SRAM banks are the smallest unit where the leakage reuse technique is applied. An overview of leakage reuse technique applied to SRAM memory is shown in FIG. 2, where leakage current from x number of donors (memory banks) is recycled to generate supply voltage for y number of receivers (logic or memory). Each donor includes a switching fabric called leakage control block (LCB) that controls the leakage flow between donor and receiver(s), while the leakage control wrapper (LC wrapper) provides the control signals to the LCBs. The LCB implemented in this work are similar to that presented in earlier approaches. The LC wrapper determines the control bit steams based on the activity of donor(s) and receiver(s) and the amount the current required for the receiver to generate a set supply voltage.

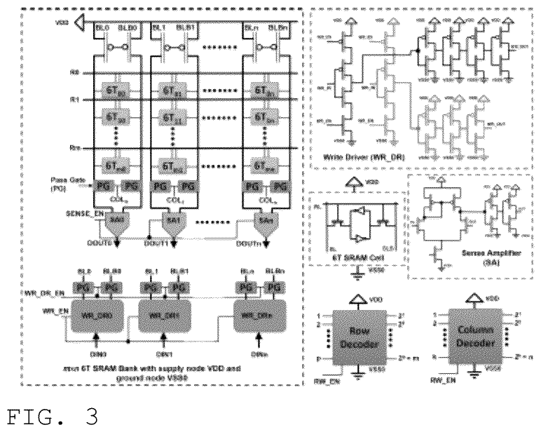

The circuit representation of bank is shown in FIG. 3, where each bank has a separate virtual ground node. Note that the circuit structure of all remaining banks is identical to the circuit of bank0. Each bank includes an m×n SRAM cell array, row/column decoders, sense amplifiers, and driver circuits as shown in FIG. 3, where in this work 16 rows (m=16) and 16 columns (n=16) are used in each bank. The complex techniques targeted for application specific implementation of state-of-art on-chip SRAM architectures such as sharing decoders, sharing sense amplifiers, and use of higher order address bits to include chip select and bank addressing are not considered in this research. The reasons are a) designing SRAM architecture is not the primary objective of this research, b) the use of SRAM architecture shown in FIG. 3 provides sufficient circuit details for the proof of concept, where the inclusion of more complex techniques will only increase the area and leakage current.

### B. Functionality of Donors During Leakage Reuse

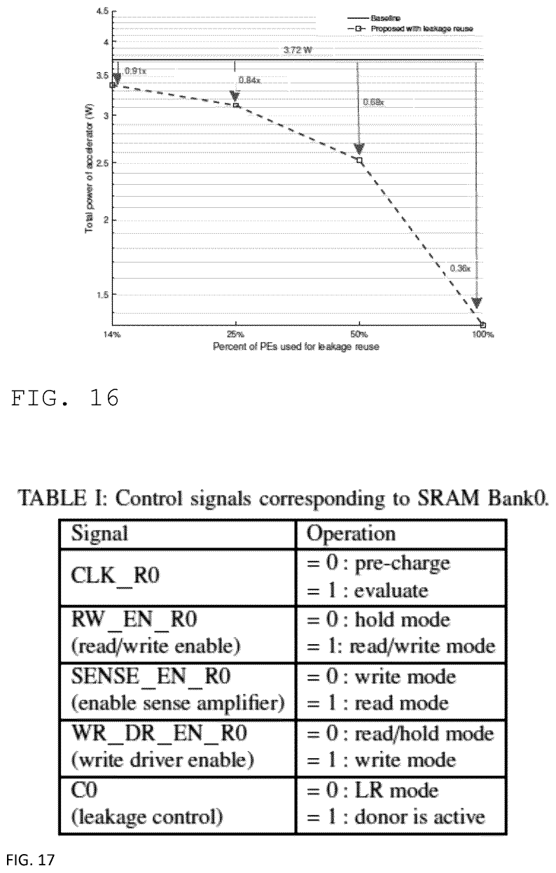

The functionality of SRAM banks (donors) and computing units (receivers) when implementing leakage reuse technique is analyzed. Four banks are used to analyze the functionality. The 6T SRAM bit cell array and the peripheral circuits within a bank are developed in 65 nm CMOS technology for SPICE simulation. The results obtained through SPICE simulation are shown in FIG. 4 where functionality of bank0 is shown, while implementing the leakage reuse technique. The addressing of a smaller sub-array (4×4) with 4-bit address is shown in FIG. 4. It is assumed that at any given time two banks are active and remaining two are idle, where Bank0 and Bank1 (Bank2 and Bank3) share the same control signals. A 4 bits carry look-ahead adder may be used as receiver, where 450 mV supply is generated for the receiver from the leakage current of two idle SRAM banks. The control signals for SRAM banks are listed in FIG. 17, Table I, where signals for only Bank0 are shown. At the beginning of the control cycle bank 0 and bank1 are active (C0=C1=1) and leakage current from two idle banks (bank2 and bank3) are used to deliver current to the adder. A logic high is written into a memory cell located at address “0100”, which is following by next control pulse that changes the state of bank0 to idle (hold state).

Therefore, the bank0 and bank1 are used for leakage reuse at this state. During the third control pulse where bank0 is active again, the stored data is retrieved correctly. Similarly, a logic low is written in the location “0000” and retrieved correctly. Therefore, the proposed technique recycles leakage current from memory banks without causing functional errors and data loss of the memory banks.

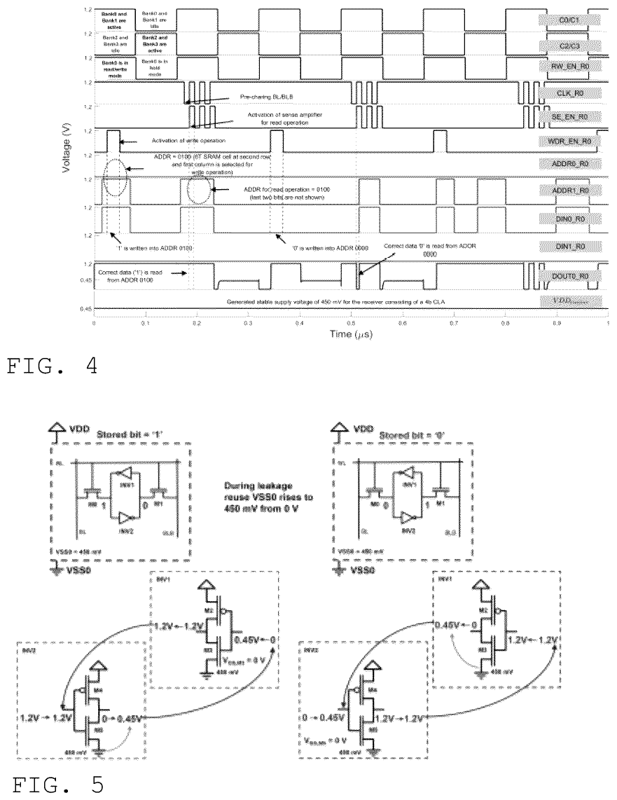

The implementation of leakage reuse technique does not perturb the stored bits on SRAM cell arrays. As an example, a bit cell from bank0 is analyzed as shown in FIG. 5. As leakage reuse technique is only applied during the hold state of the memory bank, it is vital to ensure that data is retained when the bank is returned to it's active operation modes (read/write). When the bit cell stores a logic ‘1’, the input and output of INV2 is, respectively, 1.2 V and 0 V. As the bit cell enters the leakage reuse mode, the output node of the INV2 rises to 450 mV, which also changes the input of the INV1 to 450 mV from OV. However, the rise in input voltage of INV1 does not perturb the output state of INV1 as the NMOS transistor M3 is in cut-off mode (VGS,M3=0V). Therefore, the voltage (1.2 V) on the input of INV2 remains unchanged. Similarly, when a logic ‘0’ is stored on the bit cell, the output voltage of INV1 rises to 450 mV from 0 V. In this case, the NMOS transistor M5 remains in cutt-off mode, which prevents any perturbation on the output voltage of INV2. Therefore, stored data on the SRAM cells is not perturbed by the implementation of leakage reuse technique due to the intrinsic data retention.

### C. Functionality of Receivers During Leakage Reuse

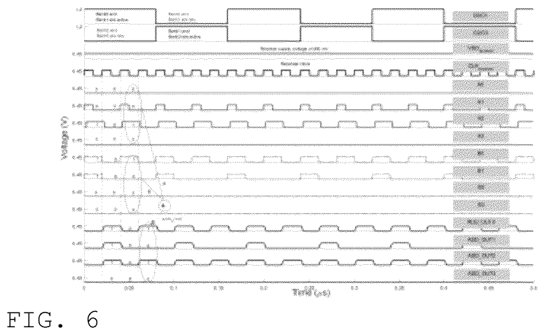

Similar to donors, the functionality of computing units (receivers) when implementing leakage reuse technique is analyzed. A 4-bits carry look-ahead adder may be used as the receiver at a supply voltage of 450 mV. The supply voltage of the adder is generated from the leakage current of two memory banks. The results obtained through SPICE simulation are shown in FIG. 6, where two 4 bit numbers (A and B) are added to produce output ADD OUT.

### 3. Heterogeneous DNN Accelerator with Multiple Voltage Domains

The development of an optimized DNN accelerator is an on-going effort in the research community. Several custom architectures were proposed in the past five years to implement DNN accelerators that provide improved performance, throughput, and energy efficiency as compared to CPU, GPU, and FPGA based implementations. However, as the neural networks are becoming deeper and diverse, new challenges are emerged due to a) the storing and management of large volume of data sets, and b) the requirement of efficient dataflow for layer-by-layer processing of DNN models. In addition, it is a challenge to implement a DNN accelerator that offers both energy efficiency and performance across diverse DNN models as the architecture of DNN accelerators is often fixed and only optimized for a sub-set of DNN models. Three challenges of DNN accelerators are discussed in the following three subsections.

### A. Storing the Large Amount of Network Parameters On-Chip

Most of the prior research focused on developing efficient hardware to compute DNN models, where an accurate characterization between on-chip and off-chip memory requirements is not studied to that extent. Recent research proposed maximizing on-chip memory size and utilization for DNN accelerators to improve the performance and energy efficiency by avoiding expensive off-chip traffic. In addition, several techniques are explored to reduce the memory footprints of deep neural networks. The memory requirements of DNN accelerators for several neural network models are profiled with the emphasis on on-chip memory size and off-chip memory bandwidth, where it is shown that increasing the on-chip memory size improves the trade-off between performance, bandwidth, and energy efficiency. Recently, a memory management technique for DNN accelerators is proposed, where the activation memory of two subsequent layers are overlapped as opposed to a ping-pong buffering technique to reduce the energy overhead of on-chip memory of the DNN accelerators.

As the DNNs are incorporating deeper and larger networks to improve the accuracy, a greater number of parameters are required to be stored in a combination of on-chip and off-chip memory. The continuous increase in memory requirements poses challenges on power and resource-constrained DNN accelerator designs, where all or majority portion of network data (activations and weights) are stored in on-chip memory to avoid energy-hungry off-chip interface. To benefit from the reduced energy per access and reduced latency of on-chip memory, state-of-the-art DNN accelerators store either both activations (inputs and outputs) and weights or one of them into on-chip memory, while in most of the cases the memories are kept separate. For example, the DaDianNao accelerator used larger on-chip memory to store all activations (4 MB) and weights (32 MB) for the executed models. The SCNN accelerator stored all activations on-chip (1.2 MB), while the weights are streamed from off-chip through a 32 KB FIFO. The Eyeriss V2 architecture used a total of 246 KB of on-chip storage for activations and weights. In addition, the EIE accelerator allocated separate on-chip storage locations for activations (128 KB) and weights (10.2 MB).

The performance and energy efficiency of state-of-the-art DNN accelerators are, therefore, constrained by the on-chip memory such as SRAM and eDRAM, where the energy required for a unit on-chip memory operation is 6× larger than the energy required for a unit computation. Activations (inputs and outputs) and weights are conventionally stored either in a global on-chip memory and/or within each PE in separate locations for activations and weights. As the recent research are targeted towards making a DNN accelerator more versatile, the memory requirement further increases as different networks require different on-chip memory sizes where the difference between minimum and maximum requirements can be order of magnitudes. Therefore, as the growth of DNN models and networks continues, a greater portion of total power of a DNN accelerator is consumed by the on-chip memory. In addition, as the size of on-chip memory is growing in accelerators, the amount of unused memory at any given time becomes a concerning issue, which results in a significant leakage energy loss.

### B. Layer-by-Layer Processing

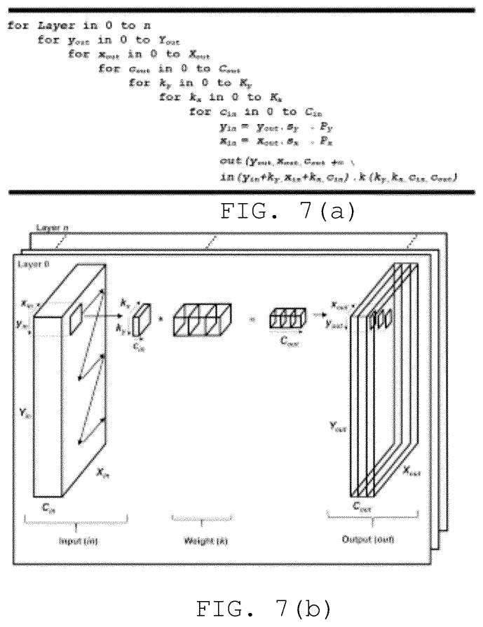

DNN models are composed of several convolution, fully connected, and activation layers, where convolution layers are the most computation and memory intensive layers. The algorithm and computation pattern of a covolutional neural network (CNN) with n number of layers are shown in FIGS. 7(a) and 7(b). In each layer, the input feature map in (Xin, Yin, and Cin) is convolved with Cout number of weight kernels k (Kx, Ky, and Cin) to produce an output feature map out (Xout, Yout, and Cout). The parameters Xin, Xout, Yin, Yout, Cin, Cout, Kx, and Ky represent, respectively, width of input, width of output, height of input, height of output, number of input channels, number of output channels, width of each filter, and height of each filter. The algorithm that implements the convolution operation for n layers is shown in FIG. 7(a). The parameters Sx, Sy, Px, and Py represent, respectively, stride in x direction, stride in y direction, padding of zeros in x direction, and padding of zeros in y direction. The representation of computation pattern of convolution operation for n layers is shown in FIG. 7(b), where each weight kernel is convolved with input feature map by sliding in x and y directions. Once the computation of first layers is completed, the output is supplied to the second layer where the same computation pattern is repeated. Therefore, the convolutional neural networks perform the processing layer-by-layer, where the output from a particular layer is used as the input of the subsequent layer. This layer-by-layer computation and data access pattern is common to all CNNs regardless of the models, the applications, and the executing hardware architecture. However, the layer-by-layer processing poses some challenges in terms of utilization of processing elements and on-chip storage.

For a given CNN model, multiple layers can exhibit different shapes, which results in different hardware configurations for PE and memory usage. Therefore, the execution of models on the accelerator SoC may be dynamically assigned through an efficient dataflow. Several optimized dataflows are proposed in recent years to maximize the utilization of PEs across all layers, which include row stationary (RO), output stationary (OS), and weight stationary (WS). However, a given dataflow can optimize the target hardware only for a sub-set of layers and models. Therefore, the challenges of efficiently utilizing on-chip memory resources and PE arrays still remains as the available PEs are not best utilized for all layers and different memory footprints are generated for each layer.

In addition, the layer-by-layer execution poses challenge in terms of on-chip memory utilization at any given time. As noted herein, the on-chip memory size is growing in recent hardware accelerators. If weights or activations of all layers are stored on-chip, only a fraction of that memory is utilized when executing a particular layer. Therefore, a significant amount of energy is lost due to the leakage current through the idle memory banks since leakage energy proportionally increases with memory size.

### C. Limited Scope of Monolithic DNN Accelerators

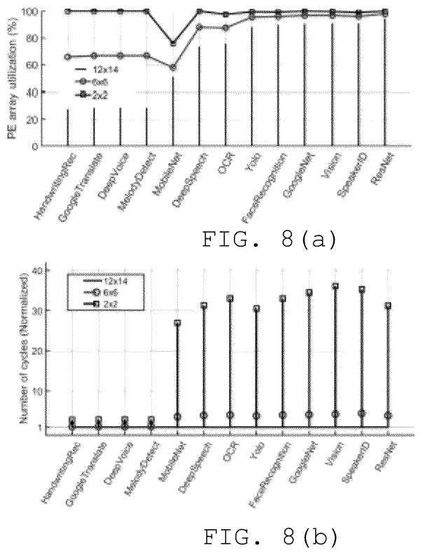

The computational requirements, on-chip memory size, and memory bandwidth vary by multiple orders of magnitude for different networks as well as across layers within a given network. Maintaining a high energy efficiency when implementing a monolithic DNN accelerator is a challenge as a given dataflow does not map diverse layers and models optimally to the available hardware resources. In this work, a Eyeriss-like architecture is characterized using a cycle accurate neural processing unit (NPU) simulator. The architecture is analyzed across a set of DNN application models with five PE array sizes (12×14, 8×6, 6×6, 4×6 and 2×2). A weight stationary (WS) dataflow is applied for all array sizes and models. The average utilization of PE array and the average number of cycles required to complete execution are characterized for a diverse set of models used for applications that include vision, object detection, and speech recognition, with results as shown in FIG. 8. The number of execution cycles is normalized to the number of cycles required by the 12×14 array. For the 12×14 PE array, the average number of cycles required to complete execution of HandwritingRec, GoogleTranslate, DeepVoice, MelodyExtraction, MobileNet, DeepSpeech, OCR, Yolo, FaceRecognition, GoogleNet, Vision, SpeakerID, and ResNet is, respectively, 0.245K, 2.84K, 2.48K, 3.627K, 206K, 1639K, 127K, 1735K, 423K, 174K, 1823K, 6007K, and 462K. The average PE utilization is less than 90% for most of the models when the PE array size is 12×14, while the PE utilization significantly increases for the smaller array sizes of 6×6 and 2×2.

Underutilization of PE arrays across hundreds to thousands of cycles results in significant loss in energy due to leakage. An increase in the utilization of PEs, therefore, results in a significant improvement of the total energy efficiency of the DNN accelerator. However, the reduction in the array size of the array results in an increase in the average number of cycles needed to complete execution of the models by 1.16× to 4.43× and 2.86× to 36× for, respectively, the array sizes of 6×6 and 2×2. The overall power-performance trade-off is, therefore, improved when the different models and layers are optimally mapped to a heterogeneous PE sub-array.

State-of-the-art edge devices execute applications that run continuously in the background (e.g. keyword detection, voice commands). A sub-set of edge devices concurrently run multiple sub-applications. As an example, edge devices executing augmented realty (AR) require concurrent execution of objection detection, speech recognition, pose estimation, and hand tracking. In addition, due to the increasing complexity and greater variety of DNN based workloads for edge devices, the resource requirements and computational loads of varying DNN workloads require dynamic allocation. Traditional DNN accelerators with monolithic architectures that are optimized to efficiently execute only a sub-set of models are not suitable for current trends in applications that require a diverse set of DNN models. Recent research proposed flexible and heterogeneous accelerators, where heterogeneous DNN accelerators are best suited to improve the performance and energy efficiency of edge devices simultaneously running a diverse set of DNN models. The heterogeneous DNN accelerator is composed of multiple sub-arrays of PEs each optimized for different layer shapes and operations. Each sub-array of PEs is mapped to a dataflow that maximizes the resource utilization and improves the overall power-performance trade-off.

In addition, monolithic DNN accelerators, where all PEs share a common power domain, limit any improvement in energy efficiency provided by techniques such as fine-grained dynamic voltage scaling, adaptive voltage scaling, and design time multiple voltage domains as all PEs are connected to a single supply voltage. For example, recently an inference processor is implemented for improved energy efficiency where all of the PEs are operated at a near-threshold voltage of 0.4 V for the entire operation cycle of the DNN. While power consumption is lowered at 0.4 V, the operating frequency (60 MHz) is also significantly reduced. Such an architecture is suitable for only a sub-set of DNN models, while the diverse models requiring energy efficiency, high performance, and throughput can not be implemented on a highly constrained homogeneous architecture.

The operating frequency of most of the state-of-the-art DNN accelerators is limited by the memory bandwidth despite the opportunity of running the computation units at much higher frequencies. For example, the Eyeriss accelerator implemented on a 65 nm CMOS process operates at a clock frequency of 200 MHz, where each PE includes either a 16 bit MAC or two 8 bit MACs. In addition, an inference processor implementing 848 KB SRAM memory operates at 120 MHz frequency at a supply voltage of 0.7 V in a 65 nm CMOS technology. Therefore, there are opportunities to improve the overall system energy efficiency by operating the computation units (MACs) at a lower supply voltage, while operating memory at a higher supply voltage.

### D. Proposed Heterogeneous DNN Accelerator Architecture Implementing Near-Memory Computing Through Leakage Reuse

A multi-voltage domain heterogeneous DNN accelerator architecture is proposed to address the challenges of monolithic DNN accelerators and energy loss due to the leakage of on-chip memory. The proposed architecture implements near-memory computing through leakage reuse technique. The proposed architecture is shown in FIG. 9, where the accelerator is composed of multiple sub-arrays with separate voltage domains as opposed to conventional designs that implement one large array with a single voltage domain (V1 in FIG. 9). The input and output activations are stored in separate global on-chip memory, where the total size for each memory block is 108 KB. The weights required by multiple layers are stored in on-chip memory (0.5 KB) within each PE, while the total memory to store weights for 168 PEs is 84 KB.

The proposed technique implements near-memory computing by generating the supply voltage for the MAC units through leakage current reuse from the adjacent idle memories that store weight parameters. The proposed leakage reuse technique discussed in Section 2 is implemented on the heterogeneous DNN accelerators. Within a processing element, the idle memory banks resulting from the layer-bylayer processing of DNN models are utilized for leakage reuse and the recycled leakage current is used to generate supply voltage for the MAC units within the same PE. When any of the sub-arrays execute a given layer L, the weights associated to only layer L is in use while the rest of the weight memory are idle within each PE of that sub-array. The idle memory banks within each sub-array are used for leakage reuse.

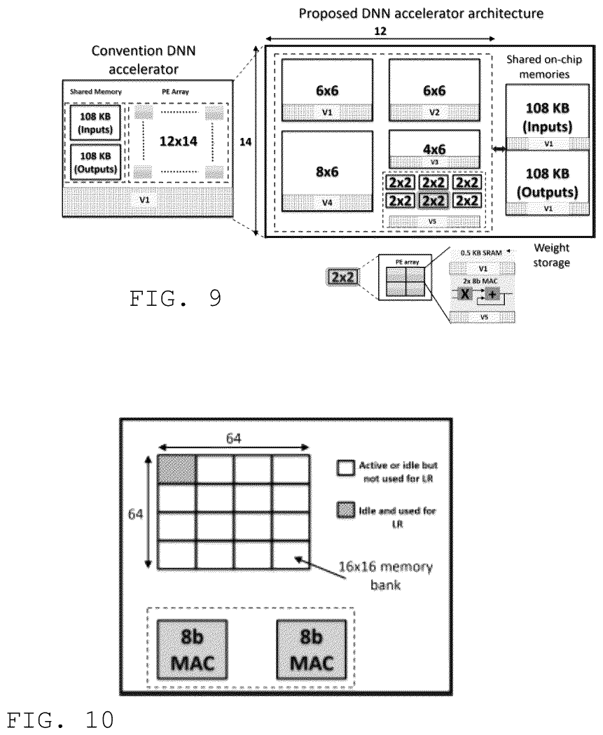

The total number of PEs, number of MACs per PE, activation memory, and the size of on-chip memory per PE are similar to that required by the Eyeriss architecture. However, unlike the Eyeriss architecture, the PEs for the proposed architecture are clustered into multiple sub-arrays with independent voltage domains. Therefore, each PE subarray executes a separate DNN model with an optimized performance-energy operating point. The block level overview of a single PE is shown in FIG. 10, where each PE contains
two fixed-point 8-bit MACs with two-stage pipelines that produces two multiply-and-accumulate results per cycle and
0.5 KB of on-chip SRAM.

### 4. Evaluation Framework

The proposed near-memory computing architecture includes heterogeneous PEs and on-chip memory are evaluated through SPICE simulation in a 65 nm CMOS technology. The DNN accelerator may include 168 PEs that are clustered into ten sub-arrays: a) one 8×6 sub-array with a throughput of 3.67 giga operations per second per watt (GOPS/W), b) two 6×6 sub-arrays each with a throughput of 2.75 GOPS/W, c) one 4×6 sub-array with a throughput of 1.84 GOPS/W, and d) six 2×2 sub-arrays each with a throughput of 0.306 GOPS/W. The six 2×2 sub-arrays are operated under the same voltage domain V5, while the two 6×6 sub-arrays are operated at two different voltage domains (V1 and V2). The number of sub-arrays and the size of each sub-array are targeted for different throughput requirement for different DNN models and different layers. In addition, the supply voltage is determined based on the required power-performance trade-offs. Although five voltage domains (V1 to V5) are implemented in FIG. 9 for fine grained power-performance trade-offs, the proposed accelerator SoC with leakage reuse technique is evaluated with only two voltage domains (V1 and V5) to characterize the throughput and the energy efficiency. The supply voltage of domain V1 and V5 is, respectively, 1.2 V and 0.45 V.

The near-memory computing architecture through leakage reuse technique is initially implemented on the smallest PE sub-array (2×2), where a supply voltage of 0.45 V is applied to the MAC units. The 0.45 V supply is generated from the recycled leakage current from the memory banks within each PE. In addition, 0.5 KB of SRAM memory in each PE, that stores the weights, includes 16 banks with each bank sized as 32 Bytes (16 16array). Therefore, the on-chip SRAM in each PE is considered as donor, while the MAC unit is considered as receiver. Through simulation it is determined that the leakage current from an idle 16×16 SRAM bank (donor) is sufficient to generate a stable supply voltage of

450 mV for two 8-bit MACs (receiver). Therefore, at any given time only one idle memory bank (16×16) is utilized for leakage reuse in a PE. In each 2×2 sub-array a total of 2 KB SRAM memory and 8 MAC units are implemented for SPICE simulation, where the architecture of memory bank is similar to that shown in FIG. 3. Each 8-bit MAC unit is designed with a radix-4 booth multiplier and a carry look-ahead adder.

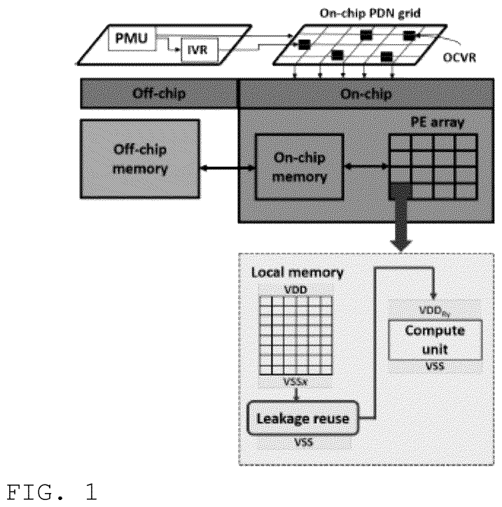

Three evaluation scenarios are considered: 1) baseline, 2) proposed without leakage reuse technique, and 3) proposed with leakage reuse technique. The difference between the three scenarios is based on the power management technique implemented in each scenario. For the baseline, a single power domain is used to deliver current to both memory banks and MAC units, where both operated at 1.2 V supply. The second scenario that implements multi-voltage domain heterogeneous DNN architecture may include two separate voltage sources for memory (operated at 1.2 V) and MAC units (operated at 0.45 V). Note that the additional circuits and voltage regulators required to generate two independent power domains for the second scenario are not included in SPICE simulation. The third scenario uses one voltage source for memory banks operated at 1.2 V, while the power for the MAC units (operated at 0.45 V) are generated from the leakage current of idle memory banks. As noted earlier, the memory banks and MAC units are considered as, respectively, donors and receivers for the third scenario. Therefore, for the third scenario the supply voltage 0.45 V of domain V5 is generated through leakage reuse, while 1.2 V is supplied by the OCVRs as shown in FIG. 1. Note that it is possible for leakage reuse technique to generate a different supply voltage for domains V2 to V4 that is either larger or smaller than 0.45 V.

### 5. Characterization of the Monolithic Accelerator Architecture

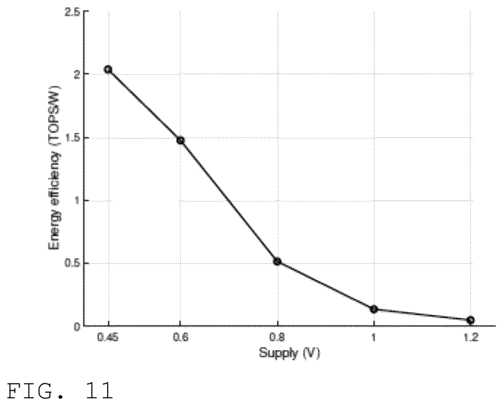

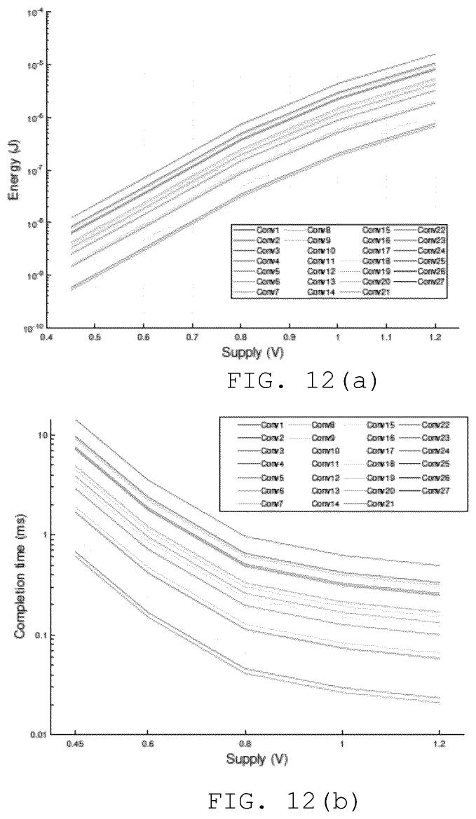

The accelerator that includes 336 MAC units within the 168 PEs are characterized for energy efficiency, represented as tera operations per second per watt (TOPS/W), across five voltage domains including 1.2 V, 1 V, 0.8 V, 0.6 V, and 0.45 V with the results shown in FIG. 11. The energy efficiency is increased with supply voltage scaling. For example, the energy efficiency of the PE array is 44.5× higher at 0.45 V (2.04 TOPS/W) as compared to the energy efficiency at 1.2 V (0.0458 TOPS/W). Therefore, the leakage reuse technique is evaluated by generating only 0.45 V supply voltage since operation at 0.45 V provides the maximum energy efficiency. In addition, the monolithic accelerator architecture is simulated with MobileNets model using a cycle accurate neural processing unit simulator to obtain the number of MAC operations required to execute each of 27 convolutional layers, which is used to calculate the energy required in each layer. The energy consumed per layer is characterized across five voltage domains and shown in FIG. 12(a). The number of MAC operations is directly proportional to the completion time of each layer as shown in FIG. 12(b), where the completion time in each voltage domain is calculated based on the minimum cycle time of the two 8 bit MACs in the respective voltage domains. For example, the Conv27 layer is the most computation intensive layer in MobileNets model and requires 3282 MAC operations when executed on the 12×14 PE array. The energy consumption (completion time) of Conv27 is 15.96 μJ (0.5 ms), 4.37 μJ (0.63 ms), 0.73 pJ (0.97 ms), 0.07 μJ (3.6 ms), and 0.01 μJ (14.4 ms) when operating under the supply voltage of, respectively, 1.2 V, 1 V, 0.8 V, 0.6 V, and 0.45 V. The Conv24 is the least computation intensive layer that requires 139 MAC operations to execute, which results in energy consumption and completion time of respectively, 0.68 μJ and 0.021 ms at a 1.2 supply voltage. Among the 27 convolutional layers the standard deviation of the number of MAC operations required is 845. Therefore, there is a significant variation in the required computation resources and completion across multiple layers of a single model (MobileNets). The variation further increases with multiple models as discussed in Section III-C. Therefore, it is beneficial to map the computation to a heterogeneous PE array based on the required number of MAC operations and latency required by different layers as well as different models.

### 6. Characterization of Energy Efficiency and Throughput of the Proposed Architecture and Leakage Reuse Technique

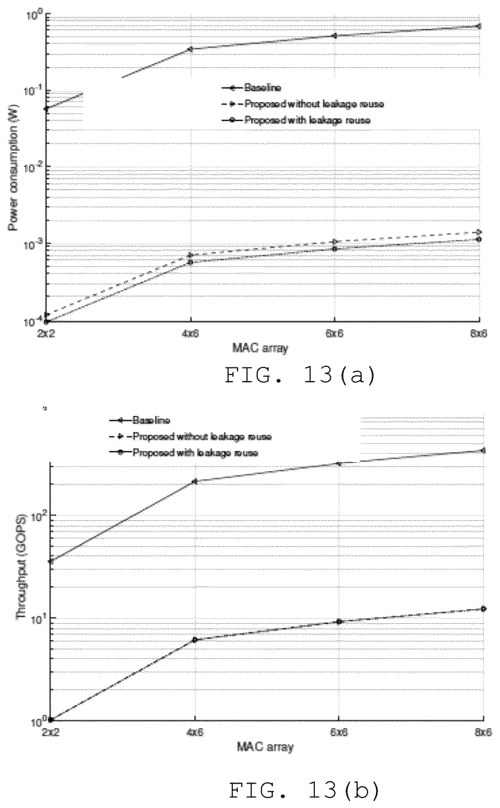

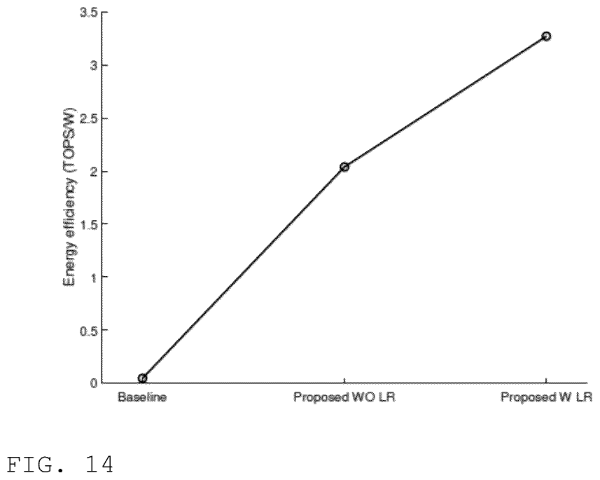

The total power consumption and the throughput of MAC arrays are characterized using the baseline, proposed multi-voltage domain heterogeneous DNN accelerator architecture with and without leakage reuse as shown in FIGS. 13(a) and 13(b). A set supply voltage of 1.2 V and 0.45 V is considered for, respectively, baseline and the proposed techniques (with and without leakage reuse) across four sub-arrays (2×2, 4×6, 6×6, and 8×6). The relative difference between three topologies in total power consumption and energy efficiency scales with sub-array size. The power consumption of the baseline is 605.5 and 487.2 the power consumption of, respectively, the proposed technique with leakage reuse and without leakage reuse. The throughput of the baseline is 35 the throughput of the proposed technique (with and without leakage reuse since same supply voltage of 0.45 V is used).

The energy efficiency of the proposed architecture (with and without leakage reuse) is compared with the baseline and shown in FIG. 14. Note that the total power consumption and delay of MAC arrays are considered when calculating the energy efficiency for each topology. The implementation of leakage reuse on the proposed architecture exhibit the maximum energy efficiency of 3.27 TOPS/W, which is 71.44 and 1.60 higher as compared to the baseline and the proposed architecture without leakage reuse.

The total power consumption of a 2 2 sub-array is characterized, where each processing element within the sub-array includes two 8-bit fixed-point MACs and a 0.5 KB memory as shown in FIG. 10. In addition, the total power of a group of six 2 2 sub-arrays (shown in FIG. 9) is also characterized.

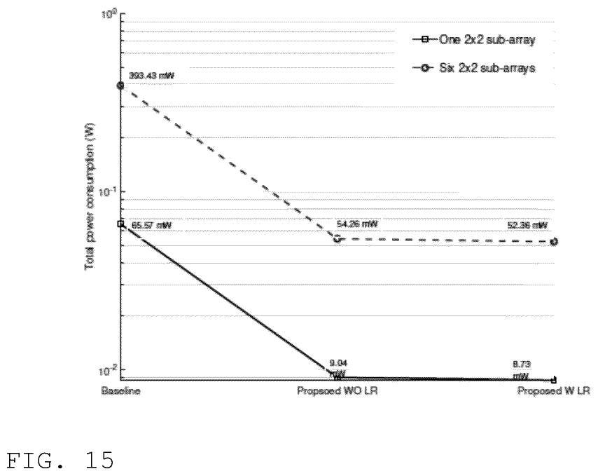

The simulation results are compared among three topologies (baseline, proposed architecture without leakage reuse, and proposed architecture with leakage reuse) explored in this paper and shown in FIG. 15. The total power consumption of one 2 2 sub-array is 65.57 mW, 9.04 mW, and 8.73 mW in, respectively, the baseline, proposed architecture without leakage reuse, and proposed architecture with leakage reuse topology. The relative comparison between three topologies are similarly scaled up when characterized for six 2 2 subarrays.

Note that leakage reuse is applied to only 6.25% of the available memory (0.5 KB) in each PE which results in 0.31 mW and 1.9 mW reduction in the total power consumption for, respectively, one and six 2×2 sub-arrays.

The six 2×2 sub-arrays constitutes 14.3% (24/168) of all PEs, where all MACs within the 2×2 sub-arrays are operated at 450 mV and memories are operated at 1.2 V supply. The total power consumption is characterized for four different percentage (14%, 25%, 50%, and 100%) of PE usage for leakage reuse as shown in FIG. 16, where it is considered that all MACs are operated at 450 mV supply. The total power consumption includes the on-chip memory (0.5 KB), MACs within each of 168 PE, and the total power consumption of 216 KB of global memory. The power savings increases as more PEs are included for leakage reuse. For example, the total power of the accelerator when implementing leakage reuse is reduced to 0.68× and 0.36× that of the baseline for respectively, 50% and 100% PE usage for leakage reuse.

### 8. CONCLUSIONS

A heterogeneous multi-voltage domain DNN accelerator architecture implements near-memory computing. The leakage current from memory banks (operated at 1.2 V) of a given PE is recycled to generate a supply voltage of 0.45 V for the adjacent MACs within the same PE. Therefore, a separate voltage source is not required for the MAC units. The proposed architecture improves the energy efficiency by 71.4 (3.27 TOPS/W) as compared to the baseline architecture that operates both memory and MAC units with a single voltage domain at 1.2 V, while the throughput has been reduced by 35×. Applying leakage reuse technique to only 6.25% of overall memory within all PEs reduces the total power consumption of a 2×2 sub-array (4 PEs) by 0.31 mW, while applying leakage reuse to all of 168 PEs within the accelerator SoC reduces the total power consumption by 2.38 W. Therefore, the proposed architecture and techniques allows for more energy efficient means of inference for ubiquitous edge devices.

### 9. EMBODIMENTS

1. A multi-voltage domain heterogeneous deep neural network (DNN) accelerator architecture comprises an architecture that a) executes multiple DNN models simultaneously with different power-performance operating points; and b) improves the energy efficiency of near-memory computing applications by recycling leakage current of idle memories.
2. The multi-voltage heterogenous DNN architecture of embodiment 1 implemented on battery operated devices with on-device intelligence executing applications including computer vision, augmented/virtual reality, face recognition, image processing, and speech applications.
3. The multi-voltage heterogenous DNN architecture of embodiment 1 implemented on battery less edge devices with on-device intelligence executing applications including computer vision, augmented/virtual reality, face recognition, image processing, and speech applications.
4. The multi-voltage heterogenous DNN architecture of embodiment 1, wherein the architecture implemented according to a circuit where the leakage current from idle on-chip storage (SRAM) is reused to deliver power to the computing units within the processing elements.
5. The multi-voltage heterogenous DNN architecture of embodiment 4, wherein a conventional power delivery system is assumed for the memory banks, where the supply voltage VDD is generated and distributed through a combination of integrated voltage regulators (IVRs) and on-chip voltage regulators (OCVRs) and a power management unit (PMU).
6. The device of embodiment 1, further comprising a bank-level reuse technique.
7. The device of embodiment 6, wherein leakage current from x number of SRAM banks (donors) are used to deliver power to y number of processing elements (receivers).
8. The device of embodiment 6, wherein each current donor comprises a switching fabric called leakage control block (LCB) that controls the leakage flow between donor and current receiver, while the leakage control wrapper (LC wrapper) provides the control signals to the LCBs.
9. The device of embodiment 8, wherein the LC wrapper determines the control bit steams based on the activity of the current donor and the current receiver and the amount the current required for the receiver to generate a set supply voltage.

While the invention has been described with reference to the embodiments above, a person of ordinary skill in the art would understand that various changes or modifications may be made thereto without departing from the scope of the claims.

1. A multi-voltage domain heterogeneous deep neural network (DNN) accelerator architecture comprises an architecture that a) executes multiple DNN models simultaneously with different power-performance operating points; and b) improves the energy efficiency of near-memory computing applications by recycling leakage current of idle memories.

2. The multi-voltage heterogenous DNN architecture of claim 1 implemented on battery operated devices with on-device intelligence executing applications including computer vision, augmented/virtual reality, face recognition, image processing, and speech applications.

3. The multi-voltage heterogenous DNN architecture of claim 1 implemented on battery less edge devices with on-device intelligence executing applications including computer vision, augmented/virtual reality, face recognition, image processing, and speech applications.

4. The multi-voltage heterogenous DNN architecture of claim 1, wherein the architecture implemented according to a circuit where the leakage current from idle on-chip storage (SRAM) is reused to deliver power to the computing units within the processing elements.

5. The multi-voltage heterogenous DNN architecture of claim 4, wherein a conventional power delivery system is assumed for the memory banks, where the supply voltage VDD is generated and distributed through a combination of integrated voltage regulators (IVRs) and on-chip voltage regulators (OCVRs) and a power management unit (PMU).

6. The device of claim 1, further comprising a bank-level reuse technique.

7. The device of claim 6, wherein leakage current from x number of SRAM banks (donors) are used to deliver power to y number of processing elements (receivers).

8. The device of claim 6, wherein each current donor comprises a switching fabric called leakage control block (LCB) that controls the leakage flow between donor and current receiver, while the leakage control wrapper (LC wrapper) provides the control signals to the LCBs.

9. The device of claim 8, wherein the LC wrapper determines the control bit steams based on the activity of the current donor and the current receiver and the amount the current required for the receiver to generate a set supply voltage.
